(19) United States
(12) Patent Application Publication
(10) Pub. No.: US 2013/0228349 A1
(43) Pub. Date: Sep. 5, 2013

(54) FIRE EXTINGUISHER HOLDING ASSEMBLY

(71) Applicant: XU YANG, Shenzhen City (CN)

(72) Inventor: XU YANG, Shenzhen City (CN)

(21) Appl. No.: 13/661,432

(22) Filed: Oct. 26, 2012

(30) Foreign Application Priority Data
Mar. 5, 2012 (CN) 201210055007.4

(51) Int. Cl. A62C 13/78

(52) U.S. Cl. 169/51

(57) ABSTRACT

A holding assembly includes a rear panel, a holder attached to the rear panel by a mounting member and a limiting member. A mounting hole and a first limiting hole are defined in the rear panel. The mounting hole includes a wide portion and a narrow portion connected with the wide portion. A securing hole and a second limiting hole are defined in the holder. The mounting member extends through the securing hole and the mounting hole. The mounting member is capable of moving between a locked position, where the mounting member is engaged with the narrow portion to prevent the holder moving away from the rear panel, and a released position, where the mounting member is engaged with the wide portion to release the holder. The limiting member extends through the second limiting hole and the first limiting hole to secure the mounting member in the locked position.

### BACKGROUND

1. Technical Field

The present disclosure relates to a fire extinguisher holding assembly.

2. Description of Related Art

Nowadays, fire extinguishers are widely used in various types of buildings to extinguish or control fires in emergency situations. The fire extinguishers are attached to a wall of the buildings by fire extinguisher holders. The fire extinguisher holders are secured to the wall by bolting, or welding, for example. It is inconvenient to mount or dismount the fire extinguisher holders.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of a fire extinguisher holding assembly in accordance with an embodiment.

FIG. 2 is an enlarged view of the circled portion II of FIG. 1.

FIG. 3 is similar to FIG. 1, but viewed from another aspect.

FIG. 4 is an enlarge view of a mounting member of FIG. 1.

FIG. 5 is a cross-sectional view taken along line IV-IV of FIG. 4.

FIG. 6 is an enlarged view of a limiting member of FIG. 1.

FIG. 7 is a partially assembled view of FIG. 1.

FIG. 8 is an assembled view of the fire extinguisher holding assembly of FIG. 1.

### DETAILED DESCRIPTION

The disclosure is illustrated by way of example and not by way of limitation. In the figures of the accompanying drawings, like references indicate similar elements. It should be noted that references to “an” or “one” embodiment in this disclosure are not necessarily to the same embodiment, and such references mean at least one.

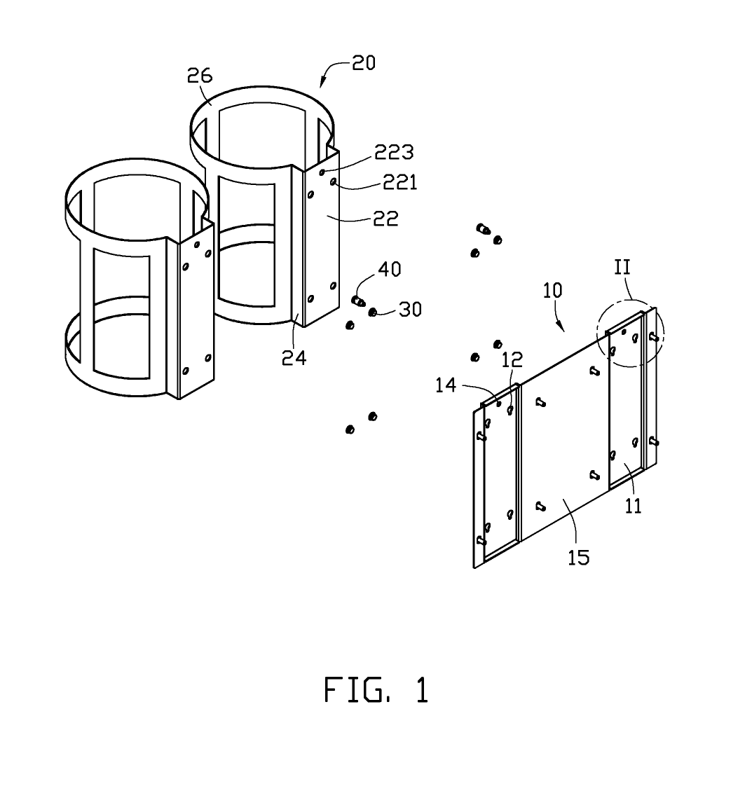

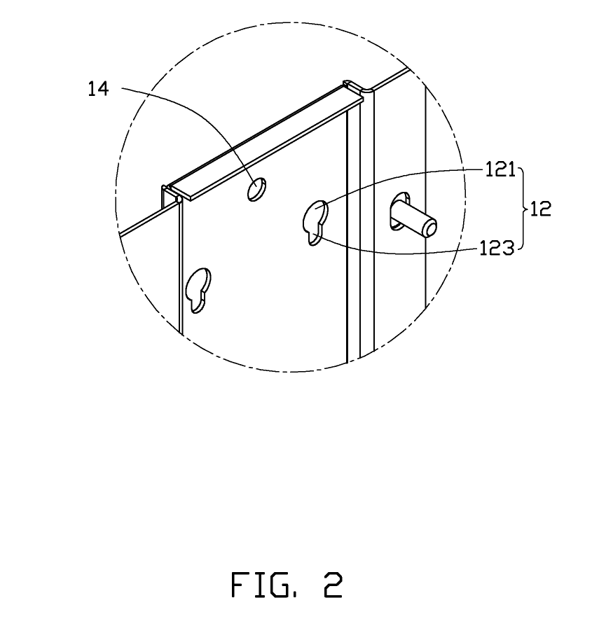

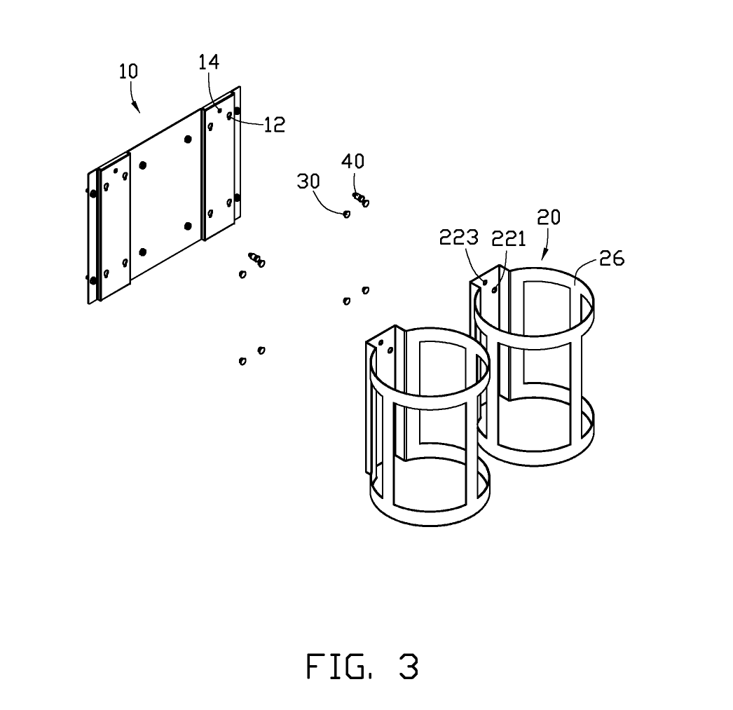

FIGS. 1 to 3 show an embodiment of a fire extinguisher holding assembly. The fire extinguisher holding assembly includes a rear panel 10, a pair of holders 20, a plurality of mounting members 30, and a pair of limiting members 40. In one embodiment, the pair of holders 20 may hold two fire extinguishers.

The rear panel 10 is integrally formed and includes a main plate 15 and a pair of rectangular protrusions 11, protruding from a front side of the main plate 15. A long edge of each of the pair of rectangular protrusions 11 is substantially parallel to a short edge of the main plate 15. A plurality of mounting holes 12 is defined in each of the pair of rectangular protrusions 11. Each of the plurality of mounting holes 12 has a calabash shape and includes a wide portion 121 and a narrow portion 123, connected with the wide portion 121. The wide portion 121 is located above the narrow portion 123. A first limiting hole 14 is defined in each of the pair of rectangular protrusions 11 and located above the plurality of mounting holes 12.

Each of the pair of holders 20 includes a flat plate 22, a pair of flanges 24 extending substantially perpendicularly from a pair of long edges of the flat plate 22, and a pair of arc-shaped encircling frames 26 connected to the pair of flanges 24. A plurality of securing holes 221 is defined in the flat plate 22, corresponding to the plurality of mounting holes 12. A second limiting hole 223 is defined in the flat plate 22, corresponding to the first limiting hole 14.

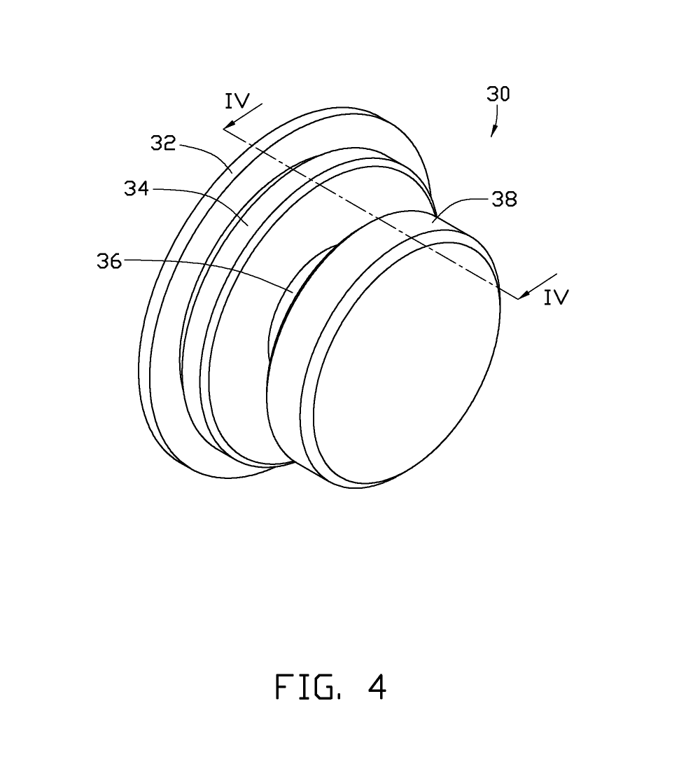

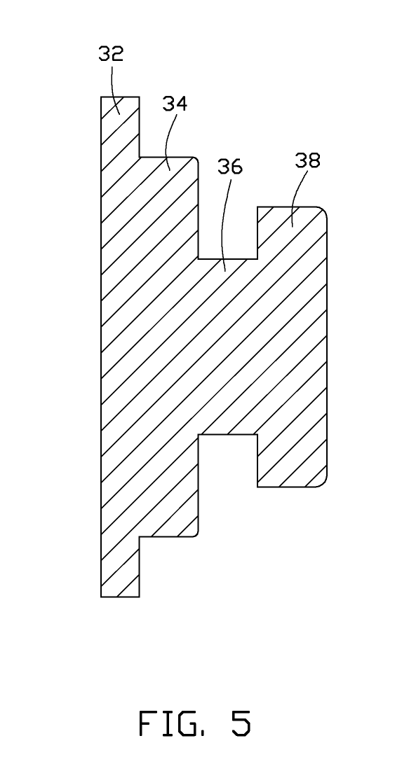

FIGS. 4 and 5 shows each of the plurality of mounting members 30 comprises a first head 32, a mounting post 34, a neck 36, and a retaining end 38. The mounting post 34 is connected to and located between the first head 32 and the neck 36. The neck 36 is connected to and located between the mounting post 34 and the retaining end 38. The first head 32 and the retaining end 38 are located at opposite distal ends of each of the plurality of mounting members 30. A diameter of the mounting post 34 is less than that of the first head 32. A diameter of the retaining end 38 is less than that of the mounting post 34. A diameter of the neck 36 is less than that of the retaining end 38. The diameter of the retaining end 38 is less than that of the wide portion 121, but it is greater than that of the narrow portion 123. The diameter of the neck 36 is less than that of the narrow portion 123. In one embodiment, the diameter of the mounting post 34 is substantially equal to that of each of the plurality of securing holes 221.

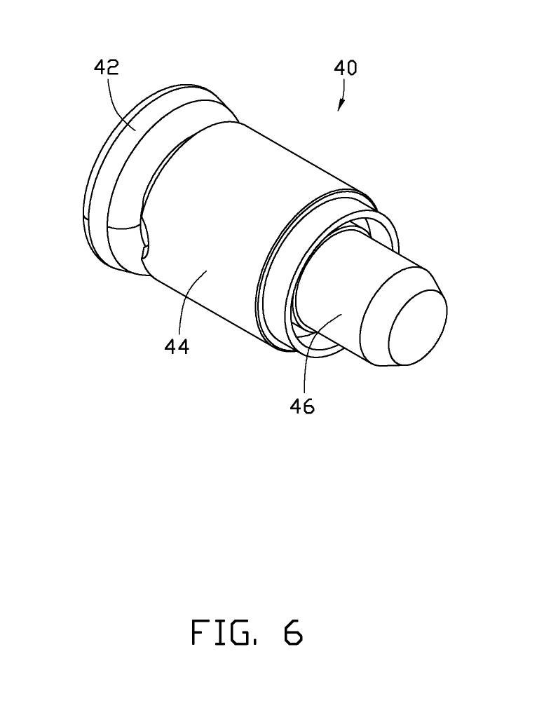

FIG. 6 shows each of the pair of limiting members 40 includes a second head 42, a hollow holder 44, and a movable post 46 partially received in the hollow holder 44. A diameter of the hollow holder 44 is less than that of the second head 42. A diameter of the movable post 46 is less than that of the hollow holder 44. In one embodiment, the movable post 46 is movable along its axial direction and returns to its original position due to a rebound force of a resilient member (not shown) mounted in the hollow holder 44.

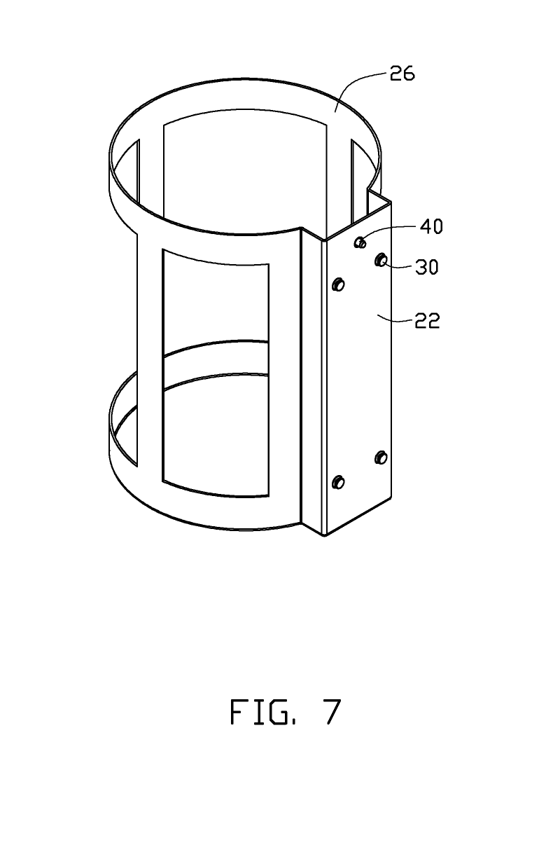

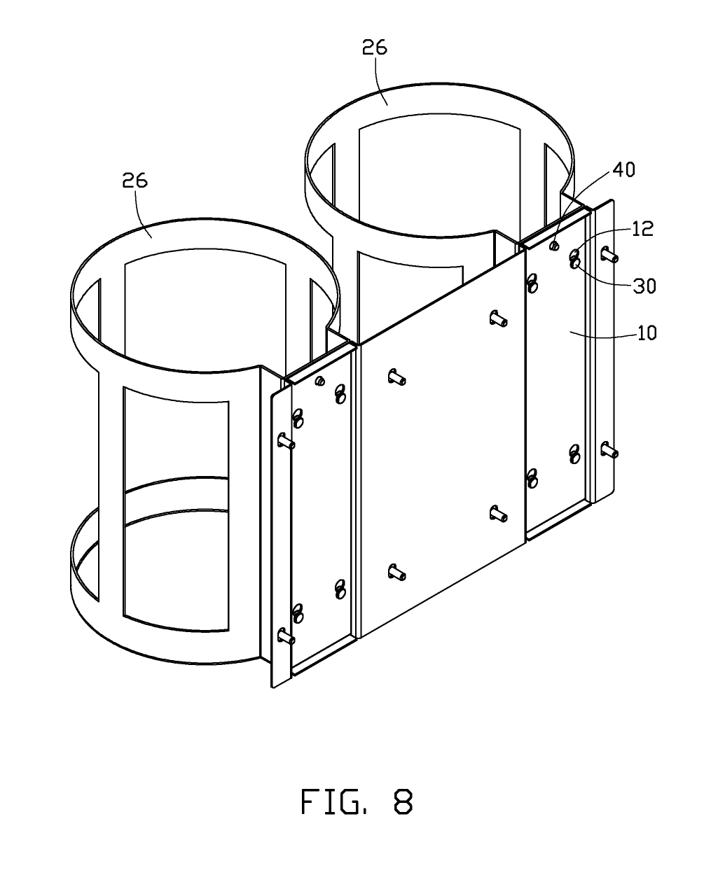

FIGS. 7 and 8 show that in assembly, the plurality of mounting members 30 extend through the plurality of securing holes 221. The mounting post 34 is engaged with and secured in each of the plurality of securing holes 221. The first head 32 abuts against an inner surface of the flat plate 22. The neck 36 and the retaining end 38 protrude out from an outer side of the flat plate 22. The hollow holder 44 is secured in the second limiting hole 223. The second head 42 is located at the inner side of the flat plate 22. The movable post 46 protrudes out from the outer side of the flat plate 22 in an original state. The movable post 46 is movable to a retracted position, where the movable post 46 is retracted into the hollow holder 44 and does not protrude out from the flat plate 22. The retaining end 38 is aligned with the wide portion 121. The movable post 46 is pressed by a front surface of the rear panel 10 and moves to the retracted position. Each of the pair of holders 20 moves downwards slightly. The neck 36 moves from the wide portion 121 to the narrow portion 123. The movable post 46 rebound to its original position and engage into the first limiting hole 14 to prevent each of the pair of holders 20 to move away from the rear panel 10 along a vertical direction. The retaining end 38 abuts a rear surface of the rear panel 10 to prevent each of the pair of holders 20, to move away from the rear panel 10 along a horizontal direction. Thus, the pair of holders 20 can be secured to the rear panel 10 by the plurality of mounting members 30 and the pair of limiting members 40.

While the present disclosure has been illustrated by the description in this embodiment, and while the embodiment has been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A holding assembly comprising:
a rear panel with at least one mounting hole and a first limiting hole defined therein, the at least one mounting hole comprising a wide portion and a narrow portion connected with the wide portion;
at least one holder with at least one securing hole and a second limiting hole defined therein;
at least one mounting member extending through the at least one securing hole and the at least one mounting hole; the at least one mounting member movable between a locked position, where the at least one mounting member is engaged with the narrow portion to prevent the at least one holder from moving away from the rear panel along a first direction substantially perpendicular to the rear panel; and a released position, where the at least one mounting member is engaged with the wide portion, and the at least one holder is disengageable from the rear panel; and
a limiting member capable of extending through the second limiting hole and the first limiting hole, to prevent the at least one holder moving away from the rear panel along a second direction substantially parallel to the rear panel.

2. The holding assembly of claim 1, wherein the at least one mounting member comprises a first head, a mounting post extending from the first head, a neck extending from the mounting post, and a retaining end extending from the neck; and the first head abuts an inner side of the at least one holder, the mounting post is secured in the at least one securing hole, the neck is engaged in the at least one mounting hole, and the retaining end protrudes out from a rear side of the rear panel via the at least one mounting hole.

3. The holding assembly of claim 2, where a diameter of the mounting post is less than that of the first head, a diameter of the retaining end is less than that of the mounting post, and a diameter of the neck is less than that of the retaining end.

4. The holding assembly of claim 3, wherein the diameter of the retaining end is greater than that of the narrow portion, but less than that of the wide portion.

5. The holding assembly of claim 1, wherein the limiting member comprises a movable post movable along its axial direction between a first position, where the movable post is engaged with the first limiting hole to prevent the at least one mounting member moving from the locked position to the released position;, and a second position, where the movable post is disengaged from the first limiting hole and the at least one mounting member is movable to the released position.

6. The holding assembly of claim 5, wherein the limiting member further comprises a second head and a hollow holder, connected with the second head; and the movable post is received in the hollow holder.

7. The holding assembly of claim 6, wherein a distal end of the movable post protrudes out from the hollow holder in the first position, and retracted into the hollow holder in the second position.

8. The holding assembly of claim 6, wherein a diameter of the hollow holder is less than that of the second head, and a diameter of the movable post is less than that of the hollow holder.

9. The holding assembly of claim 1, wherein the at least one mounting hole has a calabash shape.

10. The holding assembly of claim 1, wherein the at least one holder comprises a flat plate, a pair of flanges extending from opposite side edges of the flat plate, and an arc-shaped encircling frame extending from the pair of flanges; and the at least one securing hole and the second limiting hole are defined in the flat plate.

11. A holding assembly comprising:
a rear panel with at least one calabash-shaped hole and a first limiting hole defined therein, the at least one calabash-shaped hole comprising a wide portion and a narrow portion connected with the wide portion;
at least one holder with at least one securing hole and a second limiting hole defined therein;
at least one mounting member secured in the at least one securing hole and extended through the at least one calabash-shaped hole; the at least one mounting member capable of moving between a released position, where the at least one mounting member is engaged with the wide portion and the at least one holder is disengageable from the rear panel; and a locked position, where the at least one mounting member is engaged with the narrow portion to secure the at least one holder to the rear panel; and
a limiting member extending through the second limiting hole and the first limiting hole, to secure the at least one mounting member at the locked position.

12. The holding assembly of claim 11, wherein the at least one mounting member comprises a first head, a mounting post extending from the first head, a neck extending from the mounting post, and a retaining end extending from the neck; and the first head abuts an inner side of the at least one holder, the mounting post is secured in the at least one securing hole, the neck is engaged in the at least one calabash-shaped hole, and the retaining end protrudes out from a rear side of the rear panel via the at least one calabash-shaped hole.

13. The holding assembly of claim 12, where a diameter of the mounting post is less than that of the first head, a diameter of the retaining end is less than that of the mounting post, and a diameter of the neck is less than that of the retaining end.

14. The holding assembly of claim 13, wherein the diameter of the retaining end is greater than that of the narrow portion, but less than that of the wide portion.

15. The holding assembly of claim 11, wherein the limiting member comprises a movable post movable along its axial direction between a first position, where the movable post is engaged with the first limiting hole to prevent the at least one mounting member moving from the locked position to the released position; and a second position, where the movable post is disengaged from the first limiting hole and the at least one mounting member is movable to the released position.

16. The holding assembly of claim 15, wherein the limiting member further comprises a second head and a hollow holder connected with the second head, and the movable post is received in the hollow holder.

17. The holding assembly of claim 16, wherein a distal end of the movable post protrudes out from the hollow holder in the first position, and retracted into the hollow holder in the second position.

18. The holding assembly of claim 11, wherein the rear panel comprises a main plate and at least one protruding plate protruding out from the main plate, the first limiting hole and the at least one calabash-shaped hole are defined in the at least one protruding plate.

19. The holding assembly of claim 18, wherein the at least one holder comprises a flat plate, a pair of flanges extending from opposite side edges of the flat plate, and an arc-shaped encircling frame extending from the pair of flanges; and the at least one securing hole and the second limiting hole are defined in the flat plate.

20. The holding assembly of claim 19, wherein a shape of the flat plate is similar to that of the at least one protruding plate.
